(19) United States
(12) Patent Application Publication
(10) Pub. No.: US 2011/0011384 A1
(43) Pub. Date: Jan. 20, 2011

(54) LAUNCHING DEVICE AND METHOD

(75) Inventors: Tom Michael, Shawnee, KS (US); Ian Coats MacColl, Mill Valley, CA (US); Tony Hendrix, Oakland, CA (US); Gray Holland, Sausalito, CA (US); Paul Lapidus, Redding, CA (US)

Correspondence Address: STEVEN VOSEN, 1563 SOLANO AVENUE #206, BERKELEY, CA, 94707, US

(73) Assignee: Tom Michael, Shawnee, KS (US)

(21) Appl. No.: 12/918,196

(22) PCT Filed: Feb. 27, 2009
(86) PCT No.: PCT/US09/35473

§ 371 Date: Aug. 18, 2010

Related U.S. Application Data
(63) Continuation-in-part of application No. 61/032,323, filed on Feb. 28, 2008.
Application No. 61/032,323 is a continuation-in-part of application No. 12/393,583, filed on Feb. 26, 2009, now abandoned.
(60) Provisional application No. 61/032,323, filed on Feb. 28, 2008.

(51) Int. Cl. F41B 7/00; B28B 1/00; B29C 45/40

(52) U.S. Cl. 124/17; 124/51.1; 124/1; 425/276; 425/286; 425/282

(57) ABSTRACT

A launching device is described that includes a launcher and an optional snowball forming device. The launching device accepts objects, such as snowballs, and propels them through a generally cylindrical housing energy stored in elastic bands. One embodiment is an automatic launcher that includes an integrated snowball forming device. Uncompacted snow is provided to a hopper. The backwards motion of a handle compacts the snow into a ball and stores energy for launching, and the release of the handle propels the snowball.

### TECHNICAL FIELD

The present invention generally relates to a device for launching objects, and more particularly to a handheld device that may be used to form and/or launch objects including, but not limited to, snowballs.

### BACKGROUND ART

Snowballs are typically propelled by forming balls with ones hands and throwing them. Launching devices exist for solid objects, but there is no device specifically tailored to the forming and/or throwing of packed snowballs.

Thus there is a need in the art for a method and apparatus that permits a user to easily form and/or propel a snowball with mechanical assist. Such a method and apparatus should be easy to use and provide for the launching of other small objects.

### DISCLOSURE OF INVENTION

The present invention overcomes the disadvantages of prior art launching devices. For example, one embodiment provides a compact and easy to use launching device. Certain embodiments may be used to launch a variety of objects including, but not limited to, snowballs, water balloons, and foam balls, which may be dry or water soaked.

In certain embodiments an apparatus for launching an object is provided. The apparatus includes an elongate housing having an interior and a launch mechanism including a pocket to contain the object and to move the object in a launch direction. The mechanism is substantially within the interior, and the mechanism includes one or more elastic cords connecting the pocket to the housing.

In certain other embodiments, an apparatus for launching an object is provided. In certain embodiments, an apparatus for launching snowballs is provided. The apparatus includes a launch mechanism having a pocket to contain a snowball to be launched in a launch direction and a device to form snowballs, and the device to form snowballs is coupled to the launch mechanism.

In certain other embodiments, an apparatus for launching an object is provided. The apparatus includes a frame and a launch mechanism having a pocket to contain an object to be launched in a launch direction. The launch mechanism includes one or more elastic cords connecting the pocket to the frame.

In yet certain other embodiments, an apparatus for launching objects is provided. The apparatus includes a launch mechanism having a pocket to contain an object to be launched in a launch direction and a mechanism to provide objects to the pocket.

In certain embodiments, a method of launching snowballs in an apparatus is provided. The apparatus includes a hopper and a handle. The method includes providing snow into the hopper, moving the handle, and releasing the handle.

Certain embodiments provide a launching device with a launcher having a handle that supports a generally cylindrical portion that includes a launch mechanism. The launch mechanism includes a support with a pocket to support the object to be launched and launcher grip that are connected via one or more elastic cords to the housing. In various embodiments, objects, such as snowballs, are fed through the front, rear, or top of the housing onto the pocket, and propelled by the elastic cords when the launcher grip is released.

Certain other embodiments provide a launching device with a launch mechanism having a front elastic cord and a rear elastic cord to propel a snowball. The front and rear elastic cords are, in one embodiment, spaced laterally along the launcher grip to provide stability to the launch mechanism. In one embodiment, the front and rear cords are in different planes, adding additional stability.

Other certain embodiments provide a launching device including a snowball former. In one embodiment, the snowball former includes two portions having hemispherical inner surfaces. The surfaces are hinged together, permitting one to place snow in the snowball former, close, and then open the former to produce snowballs. In one embodiment, one of the inner surfaces includes a cut out that allows a user to grasp a snowball and remove it from the former.

Certain embodiments provide a launching device having a snowball former and a launcher. In one embodiment, the snowball former is permanently fixed to the launcher. In another embodiment, the snowball former is removable from the launcher and may have a handle for stand-alone user. In yet another embodiment, the snowball former may be mounted on the launcher in either a right-handed or left-handed configuration.

Certain other embodiments provide a snowball launching device with a snowball launcher having cushioning means to protect the snowball during launch. The cushioning means includes, in various embodiments, a soft material or radially displaced bristles.

Certain embodiments provide an automatic snowball launching device having an integral snowball former and launcher. A grip is connected to both the snowball former, to form a ball when stretching the elastic cords, and the launcher, to propel the snowball when released.

Certain other embodiments include a launch mechanism that prevents the launching of dense objects, such as rocks or snow-covered rocks.

These features together with the various ancillary provisions and features which will become apparent to those skilled in the art from the following detailed description, are attained by the launching device of the present invention, preferred embodiments thereof being shown with reference to the accompanying drawings, by way of example only, wherein:

### BRIEF DESCRIPTION OF DRAWINGS

FIG. 1A is a perspective front view of a first embodiment of a launching device;

FIG. 1B is a perspective rear view of the device of FIG. 1A;

FIG. 2 is a left view of the device of FIG. 1A showing portions of a first embodiment of a launch mechanism;

FIG. 3A is a rear view of the device of FIG. 1A;

FIG. 3B is a sectional view 3-3 showing one embodiment of a band attachment, where the bands are tubes that are fit over elongated portions of the housing;

FIG. 3C: is a sectional view 3-3 showing another embodiment of a band attachment, where the housing has a hole and where the bands are placed through the hole and knotted on the outside;

FIG. 3D is a view 4-4 showing detail of embodiments of a pocket for holding an object to be launched;

FIGS. 4A-4E are sectional views 4-4 illustrating a sequence of events in the use of the launch mechanism of FIG. 2, where FIG. 4A illustrates the mechanism in an initial position with a snowball being put in the mechanism, FIG. 4B illustrates the mechanism in the initial position with a snowball placed for launching, FIG. 4C illustrates the mechanism in a retracted, pre-launch position, FIG. 4D illustrates the mechanism during launch, and FIG. 4E illustrates the snowball being launched and the mechanism in the initial position;

FIGS. 5A and 5B are sectional views 4-4 illustrating a sequence of events in the use of a second launch mechanism having a restraining tether, where FIG. 5A illustrates the mechanism in an initial position with a snowball in place, and FIG. 5B illustrates the mechanism in a fully retracted, pre-launch position;

FIG. 6 is a perspective front view of a third embodiment of a launching device, where the snowball maker is hinged to form snowballs individually;

FIG. 7 is a perspective front view of a second embodiment of a launching device, where the snowball maker is separate from the launcher;

FIGS. 8A-8C are perspective cut-away views of an alternative embodiment launch mechanism adapted to prevent the launching of heavy objects, where FIG. 8A is a view of the mechanism, FIG. 8B is a view of the mechanism launching a snowball, and FIG. 8C is a view of the mechanism when attempting to launch heavy objects;

FIG. 9 is a perspective front view of a third embodiment of a launching device, where the device includes a snowball feeder;

FIGS. 9A and 9B are sectional views 9A-9A illustrating a sequence of events in the use of the launch mechanism of FIG. 9, where FIG. 9A illustrates the snowball feed mechanism in an initial position, and FIG. 9B illustrates the snowball mechanism having feed a snowball into the launcher;

FIGS. 10A, 10B are a top and side view, respectively, of a fourth embodiment of a snowball launching device;

FIG. 11 is a sectional view 11-11; and

FIGS. 12A-12D are sectional views 12-12 of the device in use, where FIG. 12A shows snow being provided to the device, FIG. 12B shows the forming of a snowball, FIG. 12C shows the snowball transferred into the launcher, and FIG. 12D shows the snowball being launched from the device.

Reference symbols are used in the Figures to indicate certain components, aspects or features shown therein, with reference symbols common to more than one Figure indicating like components, aspects or features shown therein.

### MODE(S) FOR CARRYING OUT THE INVENTION

Various embodiments are used for the launching of objects. For illustrative purposes, the objects are described as snowballs. It is understood that, except where explicitly stated, embodiments may be used for launching a variety of objects including, but not limited to, snowballs, water balloons, and foam balls, which may be water soaked.

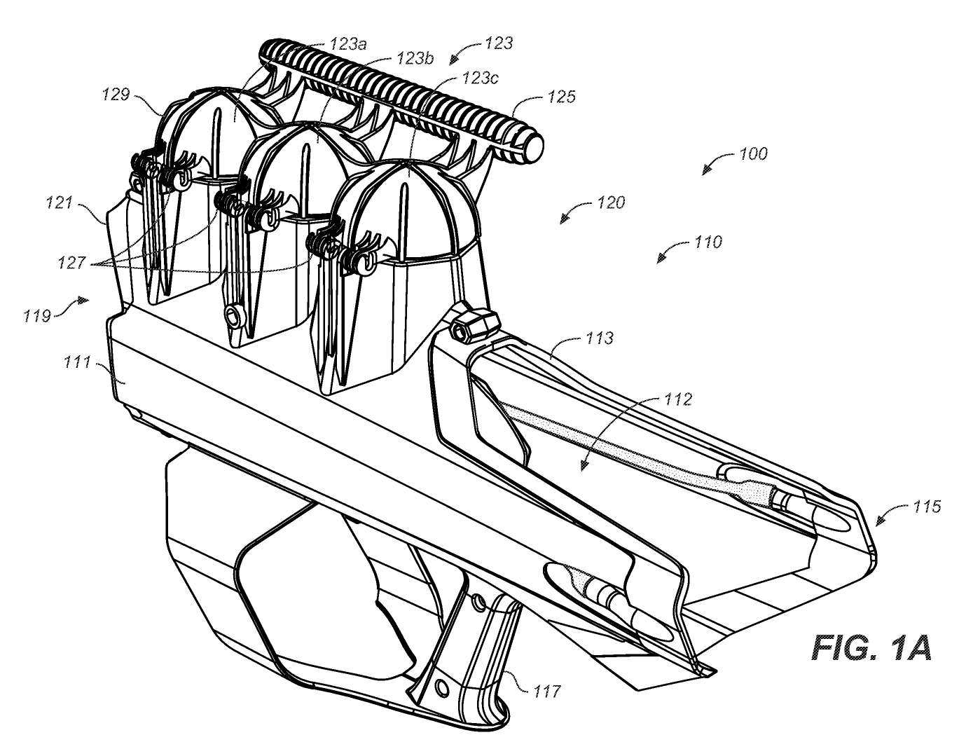

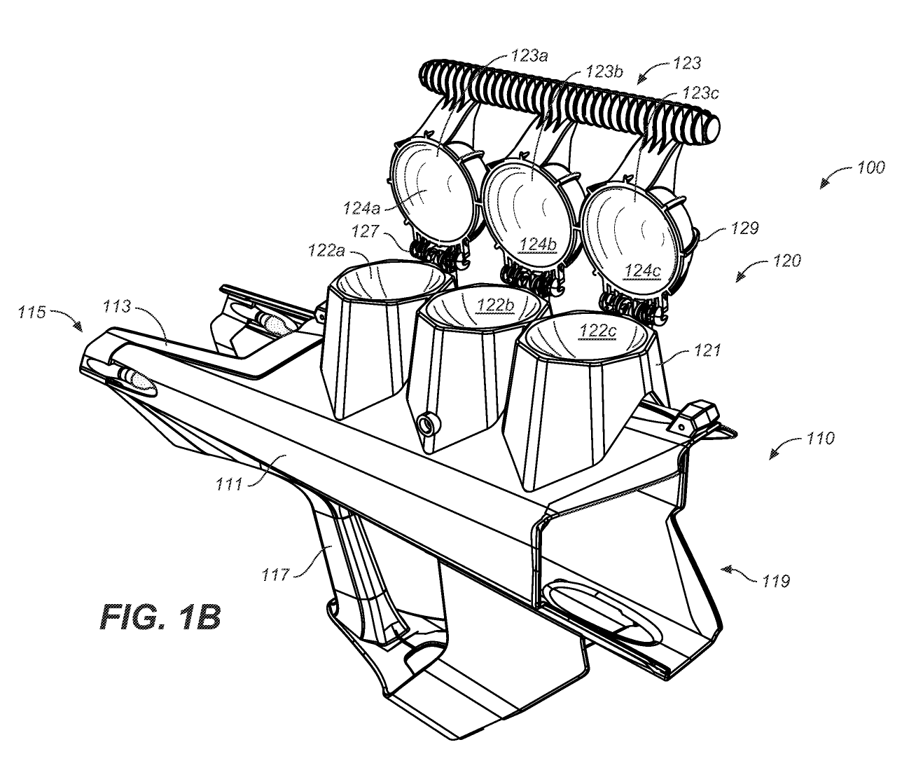

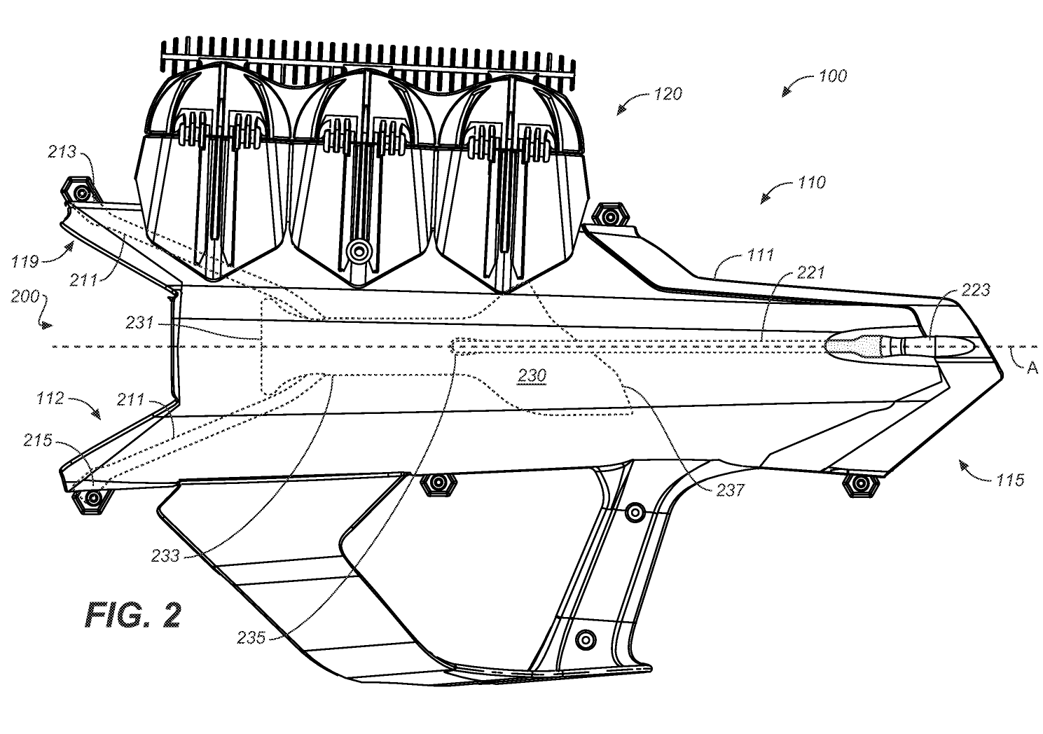

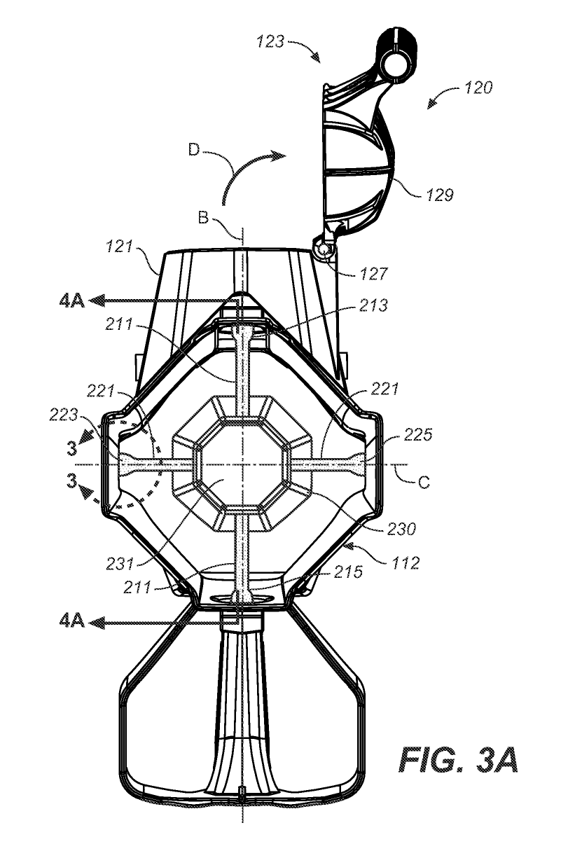

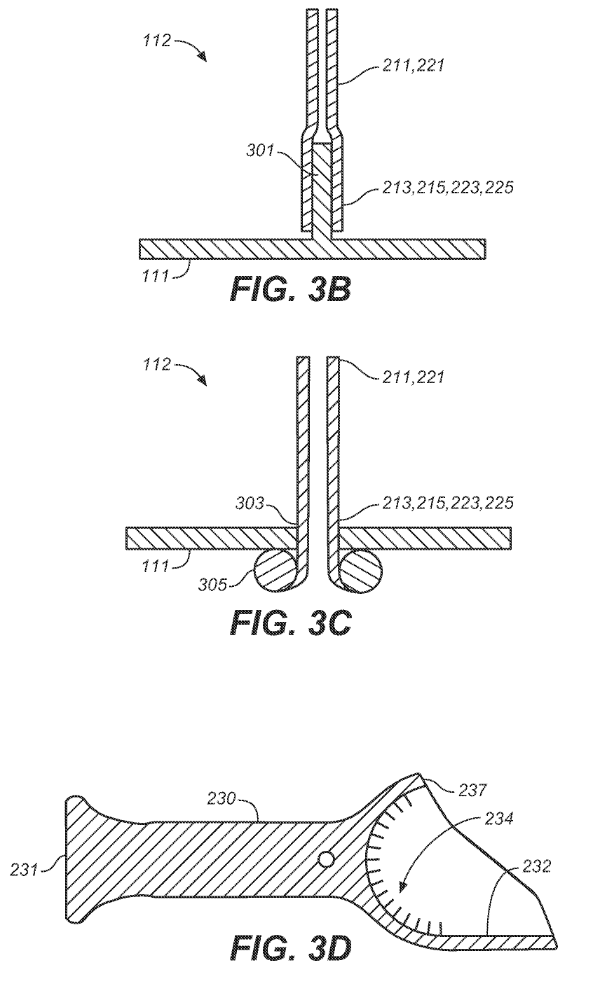

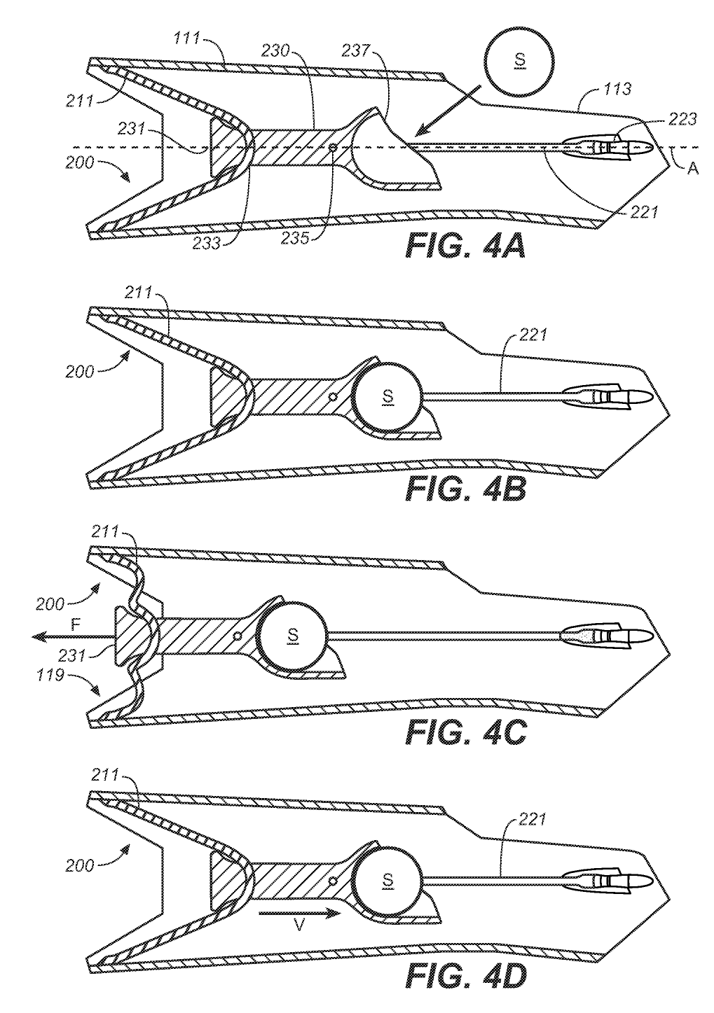

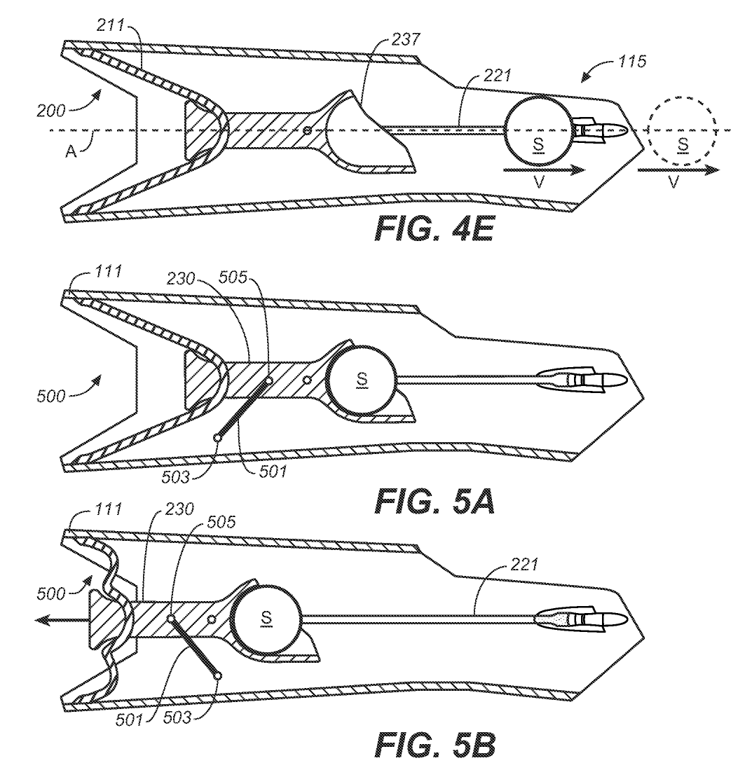

FIGS. 1-3 are views of a first embodiment of a first embodiment of a launching device 100, where FIG. 1A is a perspective front view of a first embodiment of the device, FIG. 1B is a perspective rear view of the device of FIG. 1A, FIG. 2 is a left view of the device of FIG. 1A showing portions of a first embodiment of a launch mechanism 200, and FIG. 3A is a rear view of the device of FIG. 1A.

As is best illustrated in FIGS. 1A and 1B, device 100 includes a first embodiment of a launcher 110 and a first embodiment of a snowball maker 120. In general, snowball maker 120 may be used to form one or more snowballs which may then be placed into launcher 110 and propelled away from device 100. Alternative, other objects including, but not limited to water balloons or foam balls may be launched.

Launcher 110 includes a housing 111 having an interior 112, a side opening 113, a front opening 115, a back opening 119 and a grip 117. As shown in FIGS. 2 and 3, launcher 110 includes launch mechanism 200 within interior 112 that is generally aligned a centerline A of launcher 110. The operation of mechanism 200 as used to launch an object away from device 100 and generally parallel to centerline A is described subsequently.

Snowball maker 120 may be used to form one or more snowballs. As an example, which is not meant to limit the scope of the present invention, snowball maker 120 is shown as being capable of making three snowballs. Other embodiments include the capability of forming one snowball, two snowballs, or four or more snowballs.

Snowball maker 120 includes a bottom portion 121 and a top portion 129 having a handle 125 and joined to the bottom portions by one or more hinges 127. Bottom portion 121 is shown on top of launcher 110. In one embodiment, bottom portion 121 and housing 111 are formed as one piece, for example as injection molded plastic. In another embodiment, launcher 110 and snowball maker 120 are separate pieces that are joined together, such are with adhesive or fasteners. In yet another embodiment, snowball maker 120 is removable from launcher 110, as by providing a mounting system, such as a bayonet mounting, to permit the separate use of one or the other of snowball maker and launcher. In one embodiment, snowball maker 120 may be joined to launcher 110 with handle 125 on either the right or left side of device 100.

Snowball maker 120 provides that top portion 129 may be rotated away from bottom portion 121 along hinges 127 by moving handle 125. As an example, top portion 129 has a closed position, as illustrated in FIGS. 1A and 2, may be opened, as illustrated in FIGS. 1B and 3A and indicated as arrow D on FIG. 3A The opening and closing of top portion 129 allows for the production of snowballs, as described subsequently.

Snowball maker 120 includes several snowball making compartments 123, shown as compartments 123a, 123b, and 123c. As is in FIG. 1B, the interior of each compartment 123 is formed from the interior of includes a bottom surface 122 of bottom portion 121 and a top surface 124 of top portion 129. Thus compartments 123a, 123b, and 123c are each formed from a corresponding bottom surface 122a, 122b, 122c of bottom portion 121 and a corresponding top surface 124a, 124b, 124c of top portion 129. In one embodiment, surfaces 122 and 124 of each closed compartment 123 forms a sphere.

A user can thus open compartments 123 (as in FIG. 1B), fill one or both of surfaces 122, 123 with snow, close the compartments (as in FIG. 1A), and open the compartments and remove snowballs from the compartments. Handle 125 is connected to all compartments 123, and thus snowball maker 120 may make one, two, or three snowballs simultaneously, depending on which ones of compartments 123 are filled with snow. In another alternative embodiment, surfaces 122, 124 have patterns and/or words embossed or debossed on the surface. Thus when a snowball is formed, the balls will have patterns or words on their surface.

Housing 111 of launcher 120 has top opening 113, a front end 115 and a back end 119, and contains first embodiment launch mechanism 200. Mechanism 200 is shown in phantom lines in FIG. 2 and in the end view of FIG. 3, and includes a body 230 having knob 231, a pocket 237, a rear suspension attachment 233, and a front suspension attachment 235. Knob 231 may be used by a user to provide potential energy to mechanism 200, and pocket 237 may be used contain a snowball while launching from device 100, as described subsequently.

Mechanism 200 further includes a rear band 211 and a front band 221. In general, bands 211 and 221 are elastic and support body 230 within interior 112. In one embodiment, rear band 211 is attached to housing 111 at a first attachment point 213 and a second attachment point 215, and connects or contacts body 230 at rear suspension attachment 233. Front band 221 is attached to housing 111 at a first attachment point 233 and a second attachment point 235, and connects or contacts body 230 at front suspension attachment 236.

In one embodiment, band 211 and/or 221 is single bands that are joined at attachment points 213, 215, and/or 223, and 225, and attachments 233 and 235 are holes through body 230. In another embodiment, one or more of bands 211 and 221 are two bands affixed to both housing 111 and a fastener at the corresponding attachment 233 or 235

In one embodiment, attachments 233 and 235 and bands 211 and 221 are longitudinally displaced along centerline A to provide righting forces to body 230 as it moves through the interior. In one embodiment, bands 211 are in a plane B perpendicular to centerline A and bands 221 are in a plane C perpendicular to centerline A, as shown in FIG. 3A. Bands 211 and 221 may be in the same planes that intersect at some angle. Thus, for example, planes B and C are shown as being at right angles.

FIG. 3B is a sectional view 3-3 showing one embodiment of a band attachment point, which may be for example, attachment point 213, 215, 233, and/or 235. In this embodiment, rear band 211 and front band 221 are elastic tubes, and attachment points 213, 215, 223, and 225 include cylindrical portions, shown as post 301 that protrude from housing 111 into interior 112. In one embodiment, post 301 has a diameter that is larger than the inner diameter of tubes 211 and 221, and the tubes are press-fit over the posts.

FIG. 3C is a sectional view 3-3 showing another embodiment of a band attachment, where the housing has a hole and where the bands are placed through the hole and knotted on the outside. Specifically, attachment points 213, 215, 223, and 225 are holes, show for example as hole 303 through housing 111, and bands 211, 221 are knotted on the exterior of housing 111. In an alternative embodiment, attachment points 213, 215, 223, and 225 include fasteners, such as clamps or screws.

In some embodiments, pocket 237 includes cushioning to maintain the integrity of the snowball during launch. Specifically, the acceleration of launch may cause a snowball to break apart during launch. A soft and/or compliant surface (such as rubber or a foam) and/or bristles may help prevent a snowball from breaking apart as a result of launch acceleration.

FIG. 3D is a view 4-4 showing detail of embodiments of pocket 237. Pocket 237 has an inner surface 232 that may contact a snowball for launching. In one embodiment, pocket 237 inner surface 232 includes brush-like bristles 234 that protrude radially inwards. In another embodiment, bristles 237 are not provided, and inner surface 232 is either a rigid material, such as a plastic, or includes a soft material, such as silicon or rubber.

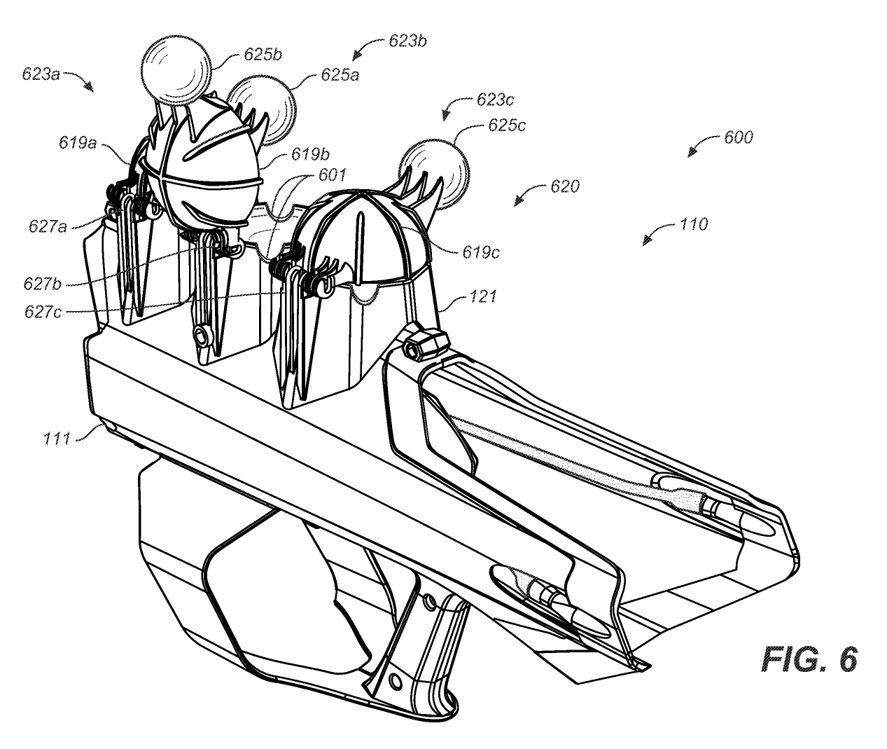

FIGS. 4A-4E are sectional views 4A-4A illustrating a sequence of events in the use of launch mechanism which may be, for example and without limitation, launch mechanism 200 of FIG. 2.

FIG. 4A illustrates mechanism 200 with body 230 in an initial, neutral position with a snowball S being placed through opening 113 into the mechanism. In an alternative embodiment, opening 113 may include a hopper or portions to direct a snowball into pocket 237. FIG. 4B illustrates mechanism 200 with snowball S placed in pocket 237.

FIG. 4C illustrates the mechanism in a retracted, pre-launch position. Thus, for example, a user places there hand through back opening 119, grabs knob 231 and pulls body 230 backwards with a force F. When body 230 is pulled back, band 211 becomes slack and band 221 stretches, storing energy for launching a snowball S.

When knob 231 is released, band 221 pulls body 230 forward, as illustrated in FIG. 4D. At some point, bands 211 and 221 pull backward on body 230, and snowball S continues forward, eventually leaving front opening 115, as shown. After launch, mechanism 200 returns to the initial position, as shown in FIG. 4E.

Each band 211 and 221 stores energy used in the longitudinal acceleration and deceleration of body 230. In addition, each band is attached to housing 111 and body 230, transferring a force transverse to centerline A in the plane of each respective band. Thus, bands 211 and 221 tend to center suspension attachment points 213 and 223, respectively.

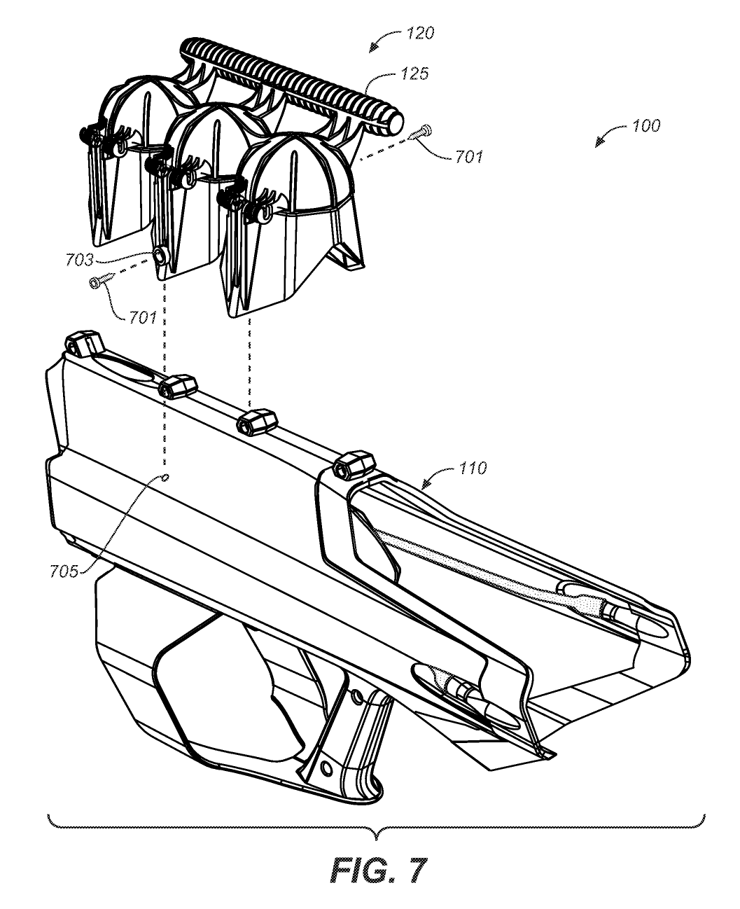

FIGS. 5A and 5B are sectional views 4-4 illustrating a sequence of events in the use of a second launch mechanism 500 having a restraining tether 501. The mechanism 500 of FIGS. 5A and 5B is generally similar to mechanism 200 of FIGS. 1-4, except as further detailed below.

FIG. 5A illustrates mechanism 500 in an initial position with snowball S in place, and FIG. 5B illustrates the mechanism in a fully retracted, pre-launch position. Mechanism 500 includes a tether 501 that is attached to housing 111 and which restrains body 230. Tether 501 is preferably less elastic that bands 221 and 221, such that the amount of energy stored in the bands is limited by the extension of the tether. FIG. 5A shows mechanism 500 in a position prior to launch, and FIG. 5B shows the mechanism pulled fully back, with tether 501 limiting the backwards motion of body 230 and thus the amount of energy that may be stored in band 221.

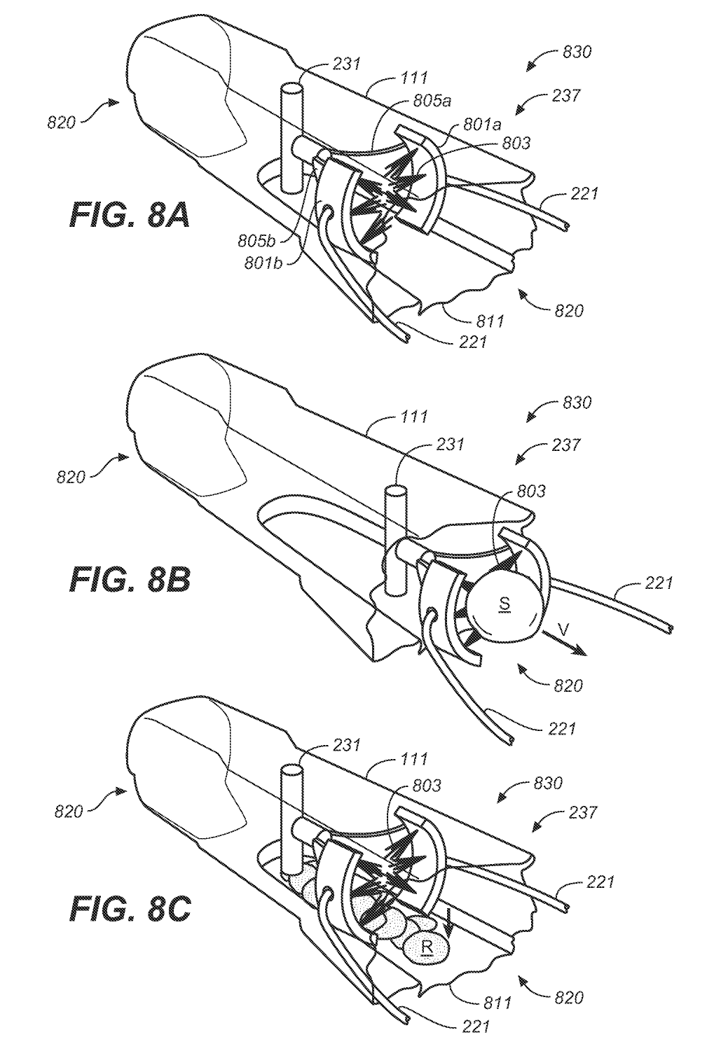

FIG. 6 is a perspective front view of a third embodiment of a launching device 600 having a snowball maker 620 hinged to form snowballs individually. Device 600 is similar to device 100, except as further detailed below.

Snowball maker 620 includes three compartments 623a, 623b, and 623c formed from three top portions 629a, 629b, 629c, each having a corresponding handle portions 625a, 625b, 625c and joined to the bottom portions 121a corresponding hinge 627a, 627b, 627c. Top portions 629a, 629b, 629c may thus be individually rotated away from bottom portion 121 for forming and/or retrieving snowballs individually.

A user can thus open compartments 623a, 623b, and 623c individually. In addition, each compartment 623 includes a pair of notches 601 on opposite sides of bottom portion 121. These notches are preferably sized and shaped to permit a user to grab a formed snowball to facilitate its removal from bottom portion 121.

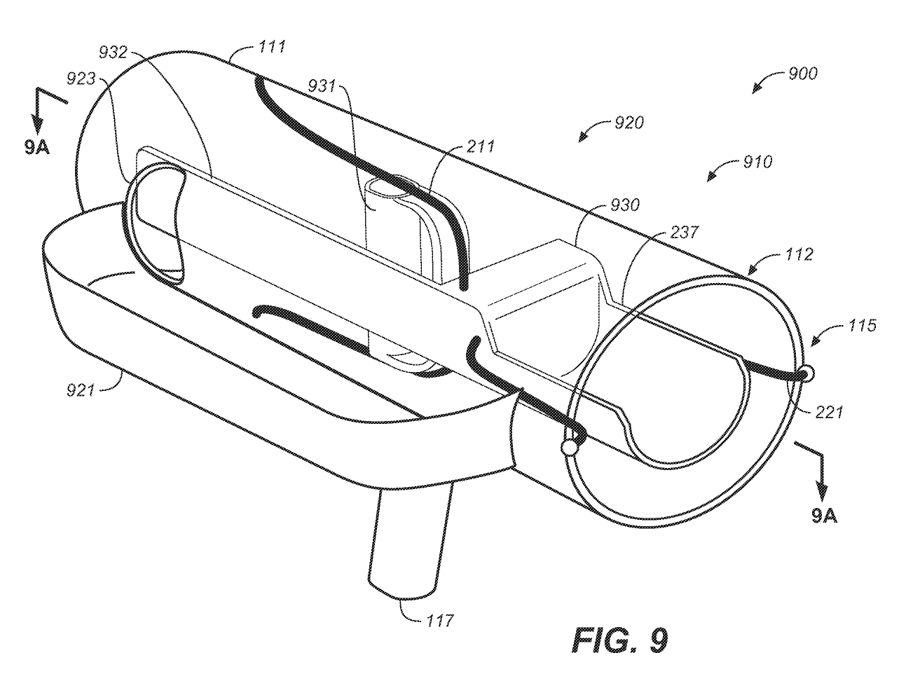

FIG. 7 is a perspective front view of a second embodiment of a launching device 700. Device 700 is generally similar to device 100 except as further detailed below.

Launching device 700 provides a removably attachable launcher 110 and snowball maker 120. Thus, as an example, screws 701 may be placed through holes 701 on snowball maker 120 and threaded into holes 705 of launcher 110. A user may thus attach snowball maker 120, as in FIG. 1A, or may remove the snowball maker and use the snowball maker and launcher 110 separately. Alternatively, device 700 permits snowball maker 120 to be reversed and placed with handle 125 on either the right or left side of launcher 110.

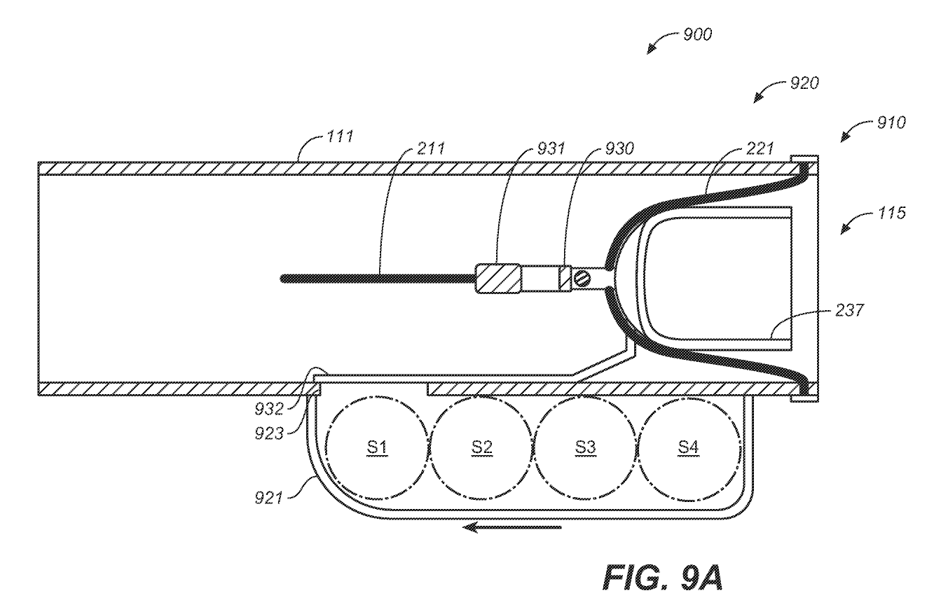

FIGS. 8A-8C are perspective cut-away views of an alternative embodiment launch mechanism 820 adapted to prevent the launching of heavy objects, where FIG. 8A is a view of the mechanism, FIG. 8B is a view of the mechanism launching a snowball, and FIG. 8C is a view of the mechanism when attempting to launch heavy objects. Launch mechanism 820 is similar to launch mechanism 200 or 500, except as further detailed below, and the launch mechanism includes a body 830 which is similar to body 230, except as further detailed below.

Mechanism 820 is adapted to preferentially accelerate objects having approximately the size and weight of a snowball, and thus prevent rocks or snow-covered rocks from being launched. In one embodiment mechanism 820 is adapted to provide a force to objects having the size and weight of snowballs and to permit other objects to fall away from the mechanism. It will be appreciated that the safety features of launch mechanism 820 may be included in other devices, such as any of devices 100, or may be used with other devices to aid in the safe use of those devices by limiting the weight and size of objects that may be launched.

The embodiment shown in FIGS. 8A-8C includes one set of bands 221 attached to body 830. In one embodiment, handle 231 is attached to a pair of portions 801a and 801b by a corresponding body portion 805a and 805b. Portions 801a and 801b, which may be curved and spaced to form portions of a ring, are spaced apart with bristles 803 protruding inwards. Portions 801 are sized and spaced to be larger that may be expected for a snowball. A plurality of inwards facing element, such as bristles 803 is provided with sufficient length and strength to contain a snowball for launching. Bristles 803 thus act as pocket 237, transferring a force to the objects for launching.

In one embodiment, launch mechanism 820 is intended to prevent rocks or snow-covered rocks from being launched. Launch mechanism 820 is thus adapted to launch objects having a density and/or size of a snowball. Examples of the use of launch mechanism 820 are illustrated in FIGS. 8B and 8C. In FIG. 8B, snowball S is accelerated by contact with bristles 801. In one embodiment, if the weight of snowball S is significantly higher than a ball of snow of the same volume, for example 25%, 50%, 75%, or 100% the weight for a snowball of the same size, then bristles 801 will bend during acceleration a sufficient amount to allow the heavy snowball to pass through ring 801 and thus not be launched launch mechanism 820. Body 111 may include an enlarged portion 811 to permit unlaunched objects to be recovered. Alternatively, enlarged portion 811 includes an opening (not shown) to permit objects to fall from the device.

Alternatively, FIG. 8C illustrates how launch mechanism 820 interacts with small objects, such as rocks R, which are much smaller than some minimum size object. Rocks R are too small be accelerated by bristles 803. Rocks R will thus pass downwards portions 801a and 801b and not be launched, and may be recovered from portion 811.

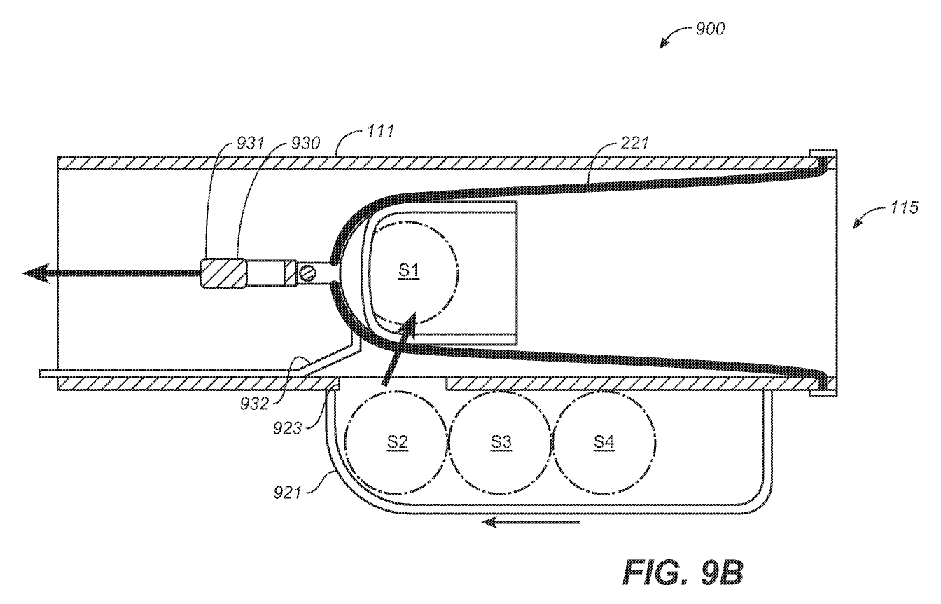

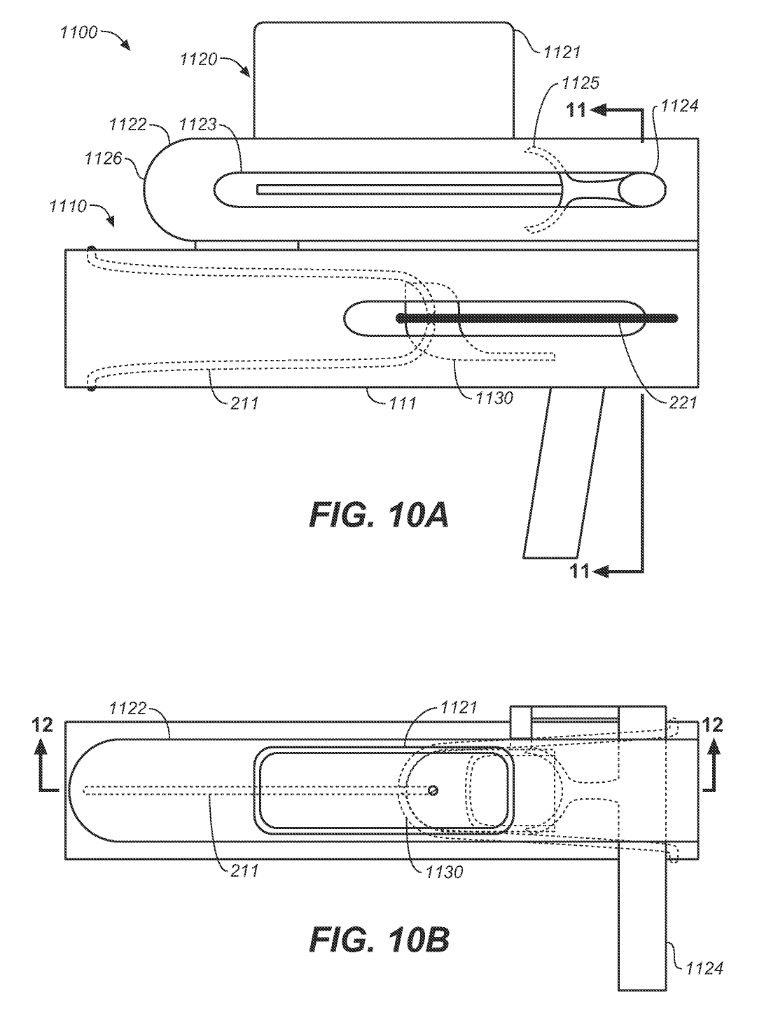

FIG. 9 is a perspective front view of a third embodiment of a launching device 900 including a launcher 910 having a body 930 and a snowball feed mechanism 920. Device 900 is similar to device 100, launcher 910 is similar to launcher 110, and body 930 is similar to body 130, except as further detailed below.

Snowball feed mechanism 920 includes a hopper 921 attached to housing 111 and a hole 923 through the side of housing 111. Body 930 includes a handle 931 and a partition 932. Partition 932 is configured to provide access from hopper 921 through hole 923 as body 930 is moved.

In one embodiment, partition 923 acts to stabilize the motion of body 930 during launch. Thus, as an alternative embodiment, other bodies, including but not limited to body 130, includes one or more protruding elements, such as partition 932 that can act to stabilize the motion of the body during launch.

FIGS. 9A and 9B are sectional views 9A-9A illustrating a sequence of events in the use launching device 900, where FIG. 9A illustrates device 900 in an initial position, and FIG. 9B illustrates device feed a snowball into the launcher. More specifically, in FIG. 9A, device 900 is in position before use (similar to the configuration of FIG. 4A) the partition 932 extends back from body 930 and covers hole 923. In FIG. 9B, device 900 is positioned energy stored in bands 221 (similar to the configuration of FIG. 4C).

Device 900 may be used as follows. One or more snowballs are formed and placed in hopper 921. For illustrative purposes, FIG. 9A shows four snowballs: S1, S2, S3, and S4. As shown in FIGS. 9A and 9B, moving body 930 backwards causes partition 932 to move backwards, permitting snowball S1 to roll through hole 932 and into pocket 237 if device 900 and/or hopper 921 are appropriately angled. Handle 931 may then be released, launching a snowball from device 900. The process may be repeated and snowball S2 may be launched.

In alternative embodiments, hole 923, partition 932, and hopper 921 are located on the opposite side of device 900, or are located or on the top of the device.

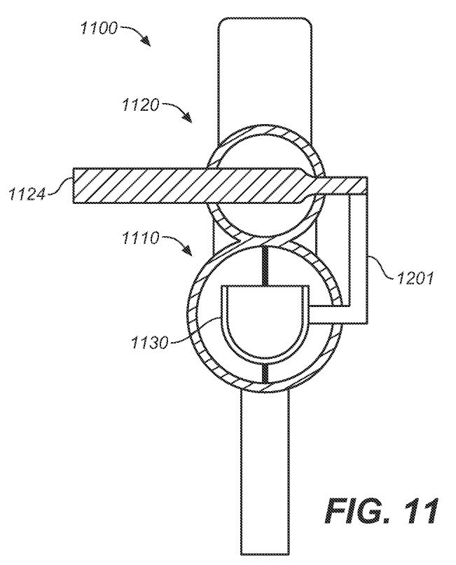

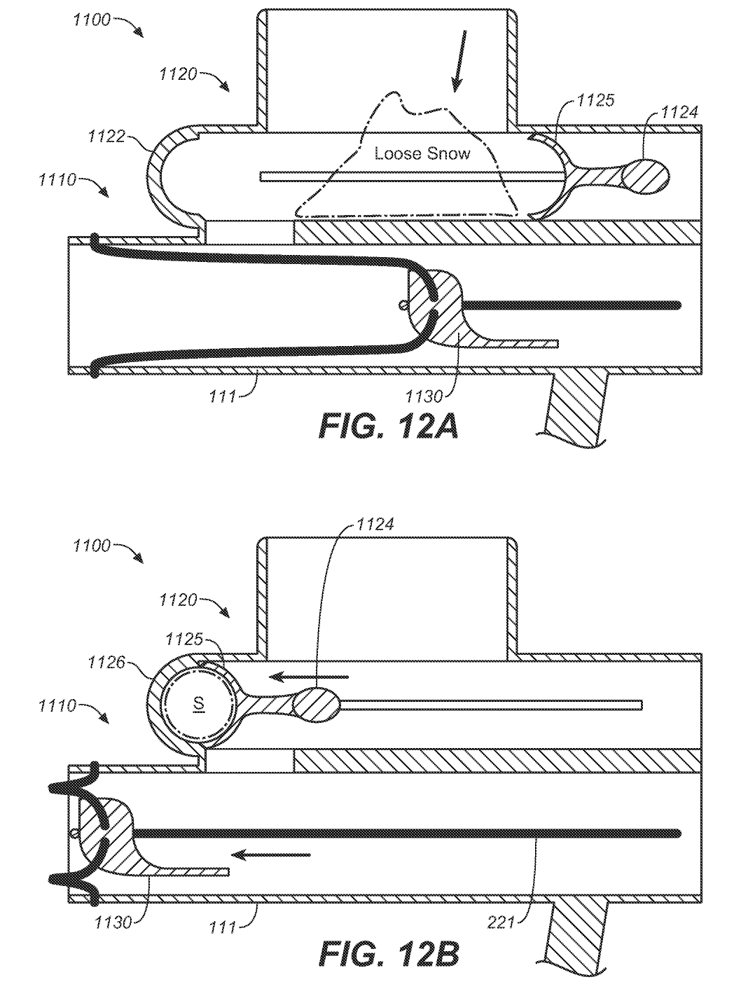

FIGS. 10A, 10B are a top and side view, respectively, of a fourth embodiment of a launching device 1100, and FIG. 11 is a sectional view 11-11 of the device. Device 1100 is similar to device 100 or 900, launcher 1100 is similar to launcher 110 or 910, and body 1130 is similar to body 130 or 930, except as further detailed below.

Device 1100 may be used as an automatic snowball former, snowball feeder, and a launching device—loose snow is provided to the device and a snowball is launched. Device 1100 includes a launcher 1100 and a third embodiment of a snowball maker 1120. Snowball maker 1120 includes a hopper 1121 and a housing 1122 containing a first compacting portion 1125 connected to handle 1124 and a second compacting portion 1126. Handle 1124 protrudes through housing 1122 through an elongated opening 1123.

Launcher 1110 includes a pocket 1130 that is attached to housing 111 by bands 211 and 231. In an alternative embodiment, only a front band (band 221) is provided. As shown in FIG. 11, handle 1124 is attached to both the pocket 1130 and first compacting portion 1125.

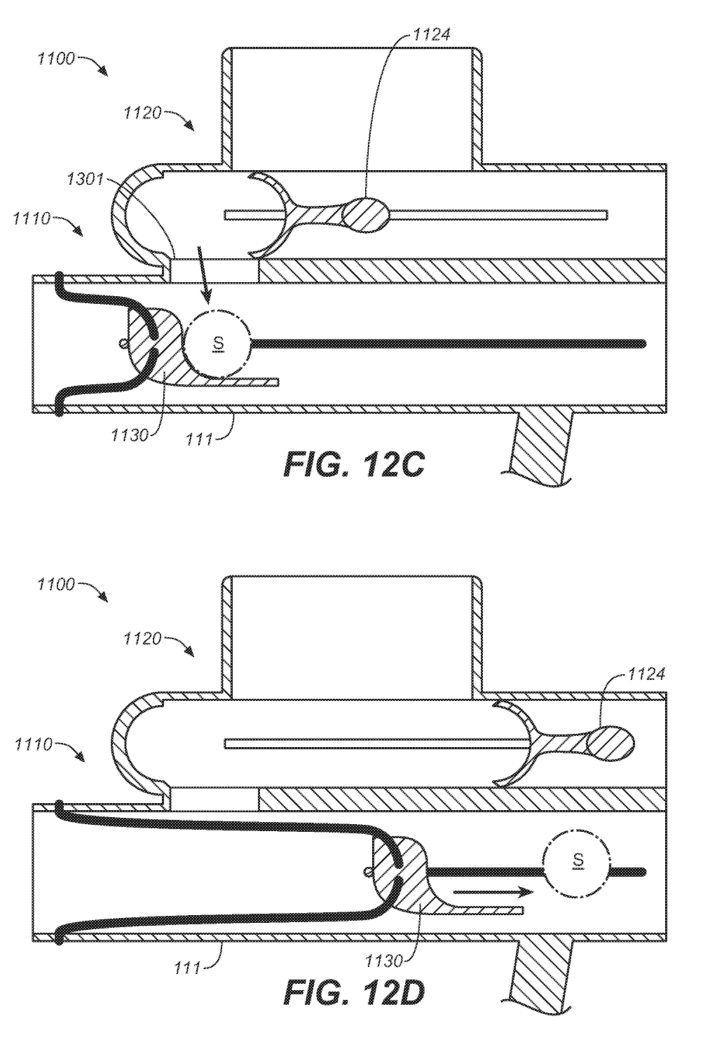

FIGS. 12A-12D are sectional views 12-12 of device 1100, where FIG. 12A shows loose snow being provided to the device, FIG. 12B shows the forming of a snowball, FIG. 12C shows the snowball transferred into the launcher, and FIG. 12D shows the snowball being launched from the device.

Specifically, FIG. 12A shows the device is a pre-loaded configuration (similar to the configuration of FIG. 4A). Loose snow is provided through the top of hopper 1121, where it then falls in to housing 1122. Next, as shown in FIG. 12B, handle 1124 is pulled back, resulting in first compacting portion 1125 pushing the loose snow back towards second compacting portion 1126. In the configuration of FIG. 12B, compacting portions 1125 and 1126 meet to form a spherical cavity, into which the loose snow is compacted to form snowball S. Also, as shown in FIG. 12B, pocket 1130 is in an extreme rear position and band 221 is fully extended.

Next, as shown in FIG. 12C, handle 1124 is pushed slightly forward. This motion permits snowball S to drop into pocket 1130. This configuration is similar to that of FIG. 4C or FIG. 9B, in that the device is loaded and ready for launching.

Next, as is shown in FIG. 12D, handle 1124 is released and a snowball is launched from device 1100.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

Reference throughout this specification to “one embodiment” “an embodiment” or “certain embodiments” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

1. An apparatus for launching an object, said apparatus comprising:
a elongate housing having an interior; and
a mechanism to launch objects, said mechanism including a pocket to contain an object and move the pocket from a back end of the apparatus to a front end of the apparatus in a launch direction,
where said mechanism includes elastic cords connecting said pocket to said housing,
where said elastic cords include a first elastic cord or cords that connect said pocket to a front portion of said housing, and
where said elastic cords include a second elastic cord or cords that connect said pocket to a back portion of said housing,
such that, when said pocket is retracted to said back and released, said first elastic cord or cords may provide a force on said pocket in a direction towards said front and said second elastic cord or cords may provide a force on said pocket in a direction towards said back end.

2. The apparatus of claim 1, where at said first elastic cord or cords are generally aligned in a first plane, where said second cord or cords are generally aligned in a second plane, and where said first plane is approximately perpendicular to said second plane.

3-5. (canceled)

6. The apparatus of claim 1, where said pocket includes a soft or compliant material.

7. The apparatus of claim 1, where said pocket includes bristles.

8. The apparatus of claim 1, further including a device to form two or more snowballs from snow.

9. The apparatus of claim 8, where said device to form snowballs is attached to said housing.

10. The apparatus of claim 6, where said device to form snowballs is removably coupled to said housing.

11-29. (canceled)

30. The apparatus of claim 8, where said a device to form snowballs includes a mold, and where said mold includes notches to facilitate a user in removing a formed snowball with the user's fingers.

31. An apparatus for launching an object, said apparatus comprising:
a launch mechanism including a pocket to contain an object to be launched in a launch direction; and
a mechanism to provide snowballs to the pocket.

32. The apparatus of claim 31, where said mechanism to provide snowballs to the pocket includes a hopper to store one or more snowballs.

33. The apparatus of claim 32, where said a mechanism to provide snowballs to the pocket is activated by the motion of launch mechanism to launch objects.

34. The apparatus of claim 31, where said mechanism to provide snowballs to the pocket accepts loose snow.

35. The apparatus of claim 34, where said mechanism to provide snowballs to the pocket includes a mold to form snowballs from loose snow.

36. The apparatus of claim 31, where said mechanism to provide snowballs to the pocket accepts formed snowballs.

37-41. (canceled)

42. An apparatus for launching an object having a size and a weight, said apparatus comprising:
a mechanism to accept the object and, if the size is greater that a predetermined volume and if the weight is less than a predetermined weight, accelerate the object.

43. The apparatus of claim 42, where said mechanism include elements that exert an acceleration force on the accepted object if the size is greater that a predetermined volume and if the weight is less than a predetermined weight.

44. The apparatus of claim 42, where the ratio of said predetermined weight to the volume of said predetermined size is larger than the density of packed snow.

45. The apparatus of claim 44, where the ratio of said predetermined weight to the volume of said predetermined size is 25%, 50%, 75%, or 100% larger than the density of packed snow.

46. The apparatus of claim 42, where said mechanism includes bristles to support an accelerating an object.

47. The apparatus of claim 1, were said apparatus has a left side and a right side, where said device to form snowballs has a hinge, and where said device may be coupled to said housing with said hinge on either said left side of said apparatus or on said right side of said apparatus.
